(19) United States
(12) Patent Application Publication
(10) Pub. No.: US 2018/0141582 A1
(43) Pub. Date: May 24, 2018

(54) TELESCOPICALLY ADJUSTABLE STEERING COLUMN

(71) Applicant: STEERING SOLUTIONS IP HOLDING CORPORATION, Saginaw, MI (US)

(72) Inventors: Joen C. Bodtker, Gaines, MI (US); Randy W. Jones, North Branch, MI (US)

(21) Appl. No.: 15/355,870

(22) Filed: Nov. 18, 2016

(51) Int. Cl. B62D 1/19; B62D 1/184; B62D 1/189

(52) U.S. Cl. CPC B62D 1/195; B62D 1/184; B62D 1/189; B60Y 2400/4024; B60Y 2304/05; B60Y 2400/414; B60Y 2304/03

(57) ABSTRACT

An extendable steering column includes a first jacket, a second jacket, an energy absorption strap, an indexing feature and a spring. The first jacket extends along an axis and the second jacket is disposed radially inward from the first jacket with the first and second jackets being in telescopic relationship to one-another. The locking shoe is in radial contact with the second jacket. The strap is fixed to the second jacket and disposed radially between the first and second jackets. The indexing feature facilitates a locked state and an unlocked state, and is carried between and defined by the strap and the locking shoe for telescopic adjustment of the steering column. The spring is disposed radially between the shoe and strap, and is constructed and arranged to bias the locking shoe radially away from the strap and toward the unlocked state.

### BACKGROUND OF THE INVENTION

The present disclosure relates to steering columns, and more particularly, to steering columns with telescopic adjustment capability.

Vehicle steering columns with telescopic adjustment capability typically utilize a first jacket fixed to a support structure and a second jacket adapted to be translated along an axis with respect to the first jacket. A locking mechanism is constructed and arranged to lock the first and second jackets together and is typically operated by a driver of the vehicle. When the driver places the locking mechanism in an unlocked position, the driver may push or pull upon a steering wheel to adjust the axial length of the steering column. The driver may then place the locking mechanism back into the locked position to fix the second jacket with respect to the first jacket.

Known locking mechanisms require a considerable number of parts and often require numerous penetrations through one or both of the jackets thus limiting design options, contributing toward manufacturing cost, and/or reinforcement attributes that may add weight. Accordingly, it is desirable to provide a more robust and telescopically adjustable steering column with less parts, reduced jacket openings, reduced weight and/or reduced manufacturing costs.

### SUMMARY OF THE INVENTION

In one exemplary and non-limiting embodiment of the present disclosure, an extendable steering column includes a first jacket, a second jacket, an energy absorption strap, an indexing feature and a spring. The first jacket extends along an axis and the second jacket is disposed, at least in-part, radially inward from the first jacket with the first and second jackets being in telescopic relationship to one-another. The locking shoe is in radial contact with the second jacket. The strap is fixed to the second jacket and disposed radially between the first and second jackets. The indexing feature facilitates a locked state and an unlocked state, and is carried between and defined by the strap and the locking shoe for telescopic adjustment of the steering column. The spring is disposed, at least in-part, radially between the shoe and strap, and is constructed and arranged to bias the locking shoe radially away from the strap and toward the unlocked state.

In another exemplary embodiment, an inner jacket assembly includes an outer jacket assembly, an energy absorption strap, and an indexing feature. The outer jacket assembly is in telescopic relation to the inner jacket assembly. The energy absorption strap is fixed to the inner jacket assembly. The indexing feature is carried between the inner jacket assembly and the energy absorption strap, and is constructed and arranged to move between a locked state preventing telescopic adjustment between the inner and outer jacket assemblies, and an unlocked state enabling telescopic adjustment.

These and other advantages and features will become more apparent from the following description taken in conjunction with the drawings.

### BRIEF DESCRIPTION OF THE DRAWINGS

The subject matter which is regarded as the invention is particularly pointed out and distinctly claimed in the claims at the conclusion of the specification. The foregoing and other features, and advantages of the invention are apparent from the following detailed description taken in conjunction with the accompanying drawings in which:

FIG. 1 is a perspective view of a steering column in accordance with an exemplary embodiment of the present invention,

FIG. 2 is a partial radial cross section of the steering column;

FIG. 3 is a partial axial cross section of the steering column;

FIG. 4 is a partial exploded perspective view of components of the steering column; and

FIG. 5 is a perspective view of a lower jacket of the steering column.

### DETAILED DESCRIPTION

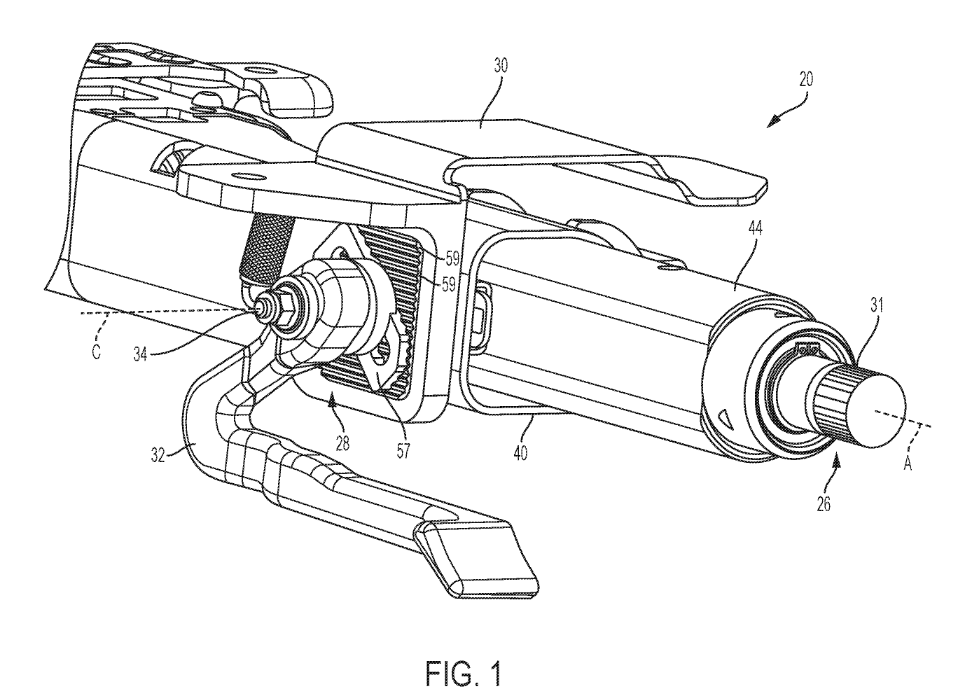

Referring now to the Figures, where the invention will be described with reference to specific embodiments, without limiting same, an extendable steering column 20 for a vehicle is illustrated. As best shown in FIGS. 1 through 3, the steering column 20 may include an upper jacket assembly 22, a lower jacket assembly 24, a rotating steering shaft 26, an actuator 28 that may be a clamping mechanism, and a fixed, stationary, bracket or support structure 30. The upper jacket assembly 22 may be disposed, at least in-part, radially inward of the lower jacket assembly 24, and is telescopically and adjustably received into the lower jacket assembly 24 along a rotational axis A associated with the steering shaft 26.

The steering shaft 26 includes an end portion 31 (see FIG. 1) that may be splined for attachment of a steering wheel (not shown). The upper jacket assembly 22 may provide, at least in-part, rotational support for the steering shaft 26 disposed radially inward from the jacket assemblies 22, 24. The steering shaft 26 may be axially segmented into two parts with a splined coupling that facilitates axial extension associated with the telescopic adjustment capability of the upper jacket assembly 22 relative to the lower jacket assembly 24. The support structure 30 supports the jacket assemblies 22, 24, the steering shaft 26, and the clamping mechanism 28 in any variety of ways that enables operation of various components including axial extension and rake adjustment capability of the steering column 20.

The actuator 28 may be a cammed clamping mechanism constructed and arranged to convert rotational motion along a centerline C into linear motion along the same centerline. The clamping mechanism 28 may be adapted to place the steering column 20 into locked and unlocked states. When the steering column 20 is in the locked state, the steering column is generally not adjustable. When the steering column is in the unlocked state, the assembly is adjustable telescopically along axis A, and may further be adjustably in a rake or tilt direction (i.e., the preferred tilt angle of the steering wheel). The clamping mechanism 28 is operably supported by the support structure 30, and may include a lever 32, a clamp bolt 34, and a device 36 that may be a cammed device known to one having skill in the art. The lever 32 enables an operator to rotate the bolt 34 about the centerline C, which generally operates the cam device 36 causing the bolt to also move linearly (i.e., axially) along the centerline C. This linear motion orientates various components, which place the steering column 20 into the locked and unlocked states. It is contemplated and understood that the actuator 28 may be any type of mechanism capable of shifting the lower jacket 40 in a direction that is substantially normal to axis A. It is further contemplated and understood that the device 36 may be any device capable of move the clamp bolt 34 along the centerline C.

The steering column 20 may further include an energy absorption (E/A) strap 38 that may be U-shaped, and is generally known by one skilled in the art for the absorption of energy when a substantial axial force is applied to, for example, the steering wheel. The lower jacket assembly 22 may include a lower or outer jacket 40 and a clamp jaw 42. The upper jacket assembly 24 may include an upper or inner jacket 44, and a locking shoe 46. One end portion of the E/A strap 38 may be fixed and engaged to the upper jacket 44, and an opposite end portion of the E/A strap 38 may be releasably, and adjustably, engaged to the locking shoe 46 of the upper jacket assembly 24.

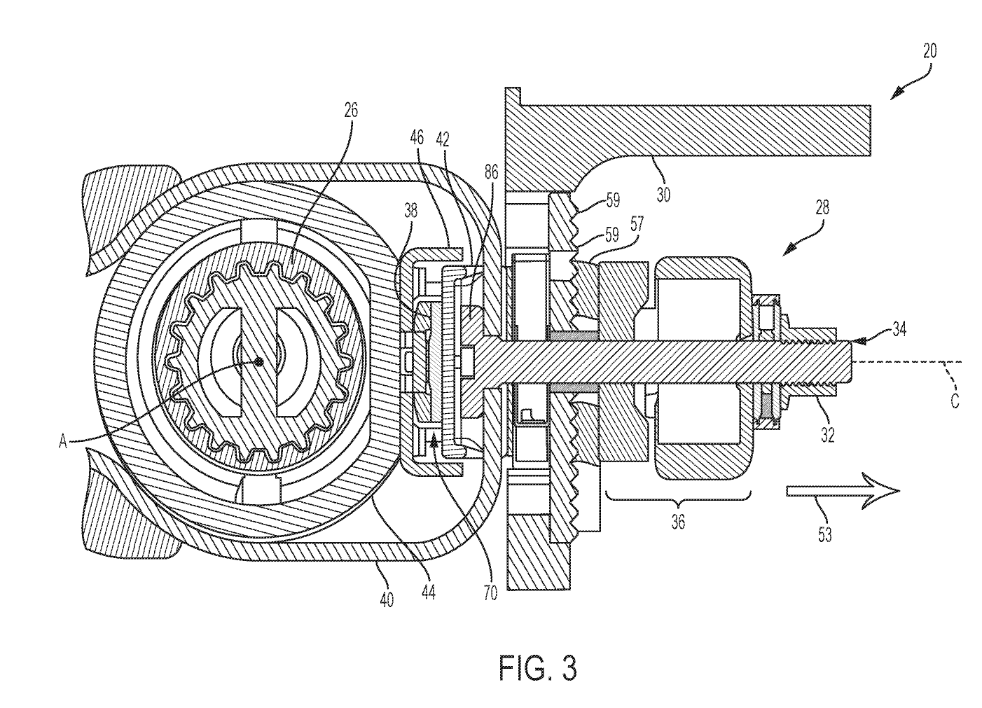

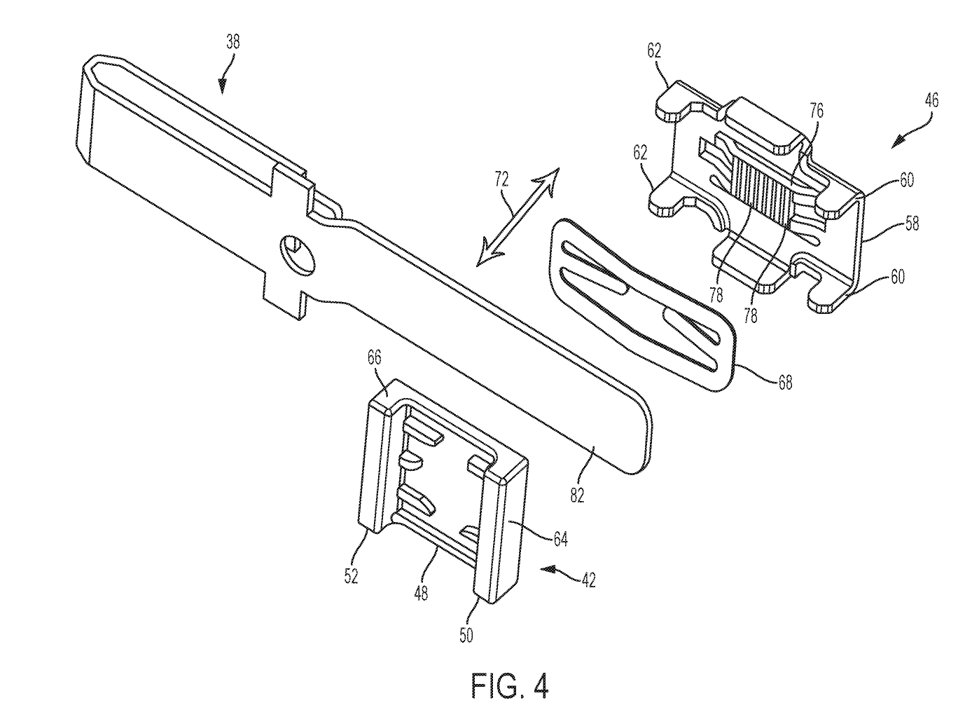

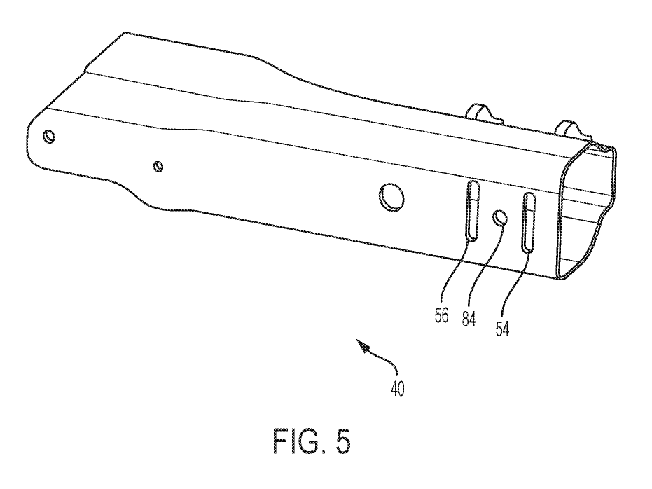

Referring to FIGS. 4 and 5, the clamp jaw 42 may include a base portion 48 and at least one foot (i.e., two illustrated as 50, 52). The feet 50, 52 may project radially outward from the base portion 48 with respect to axis A and in a radial direction identified by arrow 53 in FIG. 3. When the steering column 20 is assembled, each foot 50 projects through a respective slot or opening 54, 56 (see FIG. 5) that communicate through a wall of the lower jacket 40 that may be circumferentially continuous. The base portion 48 may span axially between the feet 50, 52, therefore the slots 54, 56 are axially separated from one-another. The width of each slot 54, 56 (i.e., taken in an axial direction with respect to axis A) is substantially equal to or slightly greater than the width of each foot 50, 52. This closeness in dimension generally prevents axial movement of the clamp jaw 42 with respect to the lower jacket 40. Furthermore, distal ends of the feet 50, 52 may contact the stationary support structure 30 preventing any movement of the clamp jaw 42 in the radially outward direction 53.

During rake adjustment of the steering column 20, the bolt 34 moves with the lower jacket 40. The rake position of the steering column 20 may be locked in place utilizing the actuator 28, and by the friction between the feet 50, 52 of the clamp jaw 42 and the structure or bracket 30 when the column is locked. Furthermore, the desired rake position may also be locked in place by an eccentric tooth cam 57 of the actuator 28 mating with teeth 59 carried by the structure 30 (see FIGS. 1 and 3).

Axial motion of the locking shoe 46 with respect to the clamp jaw 42 is restricted, or prevented, by the coupling or abutment of the locking shoe 46 to, or against, the clamp jaw 42. More specifically, the axial movement between the locking shoe 46 and the clamp jaw 42 with respect to the axis A may be generally prevented via this coupling while the upper jacket 44 moves axially with respect to the locking shoe 46 during telescopic adjustment of the steering column 20. In one embodiment, the locking shoe 46 may slide against the upper jacket 44 during telescopic motion and while the steering column is in the unlocked state. Although the locking shoe 46 does not move axially with respect to the clamp jaw 42, the locking shoe 46 is constructed and arranged to move radially with respect to the clamp jaw 42 when the assembly is placed in and out of the locked state.

The locking shoe 46 may include a base segment 58 and at least one arm (i.e., two pairs of arms illustrated as 60, 62). The arms or pairs 60, 62 may project outward from the base segment 58, and in the outward radial direction 53. When assembled, each arm 60, 62 may be disposed at opposite, axial, end faces 64, 66 carried by the base portion 48 or respective feet 50, 52 of the clamp jaw 42, for contact thereof during telescopic motion. The base segment 58 may span axially between the arms 60, 62, and is disposed radially between the upper jacket 44 and the E/A strap 38. Likewise, the E/A strap 38 may be disposed radially between the base segment 58 of the locking shoe 46 and the base portion 48 of the clamp jaw 42. The arms 60, 62 may be spaced laterally outward from respective edges of the E/A strap 38.

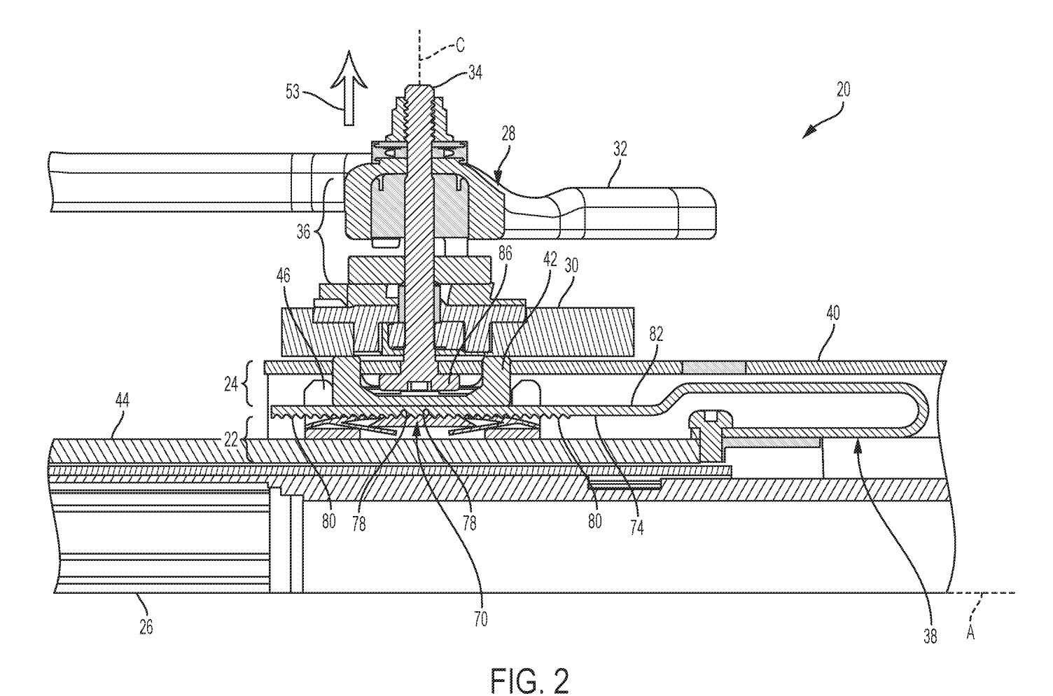

Referring to FIGS. 2, 3 and 4, the steering column 20 further includes a spring 68 and a telescopic indexing feature 70. The spring 68 may be radially disposed between, and exerts a radial force (see arrow 72 in FIG. 4) upon, the base segment 58 of the locking shoe 46 and the E/A strap 38. The radial force 72 biases the locking shoe 46 radially away from the E/A strap 38 when the steering column is in either of the locked and unlocked states. That is, the radial force 72 biases the steering column toward the unlocked state. The spring 68 may be any variety of resiliently flexible members capable of exerting a sufficient force to bias adjacent components. Examples of a spring 68 include a leaf spring, a spring clip, and others.

The indexing feature 70 facilitates the positioning of various components of the steering column 20 in and out of the locked state. The indexing feature 70 may be carried between the base segment 58 of the locking shoe 46 and an inward side 74 of the E/A strap 38. The base segment 58, or a raised platform 76 of the base segment 58, may carry or define a plurality of teeth 78 of the indexing feature 70 (see FIGS. 2 and 4) that are laterally distributed, side-by-side, to one another and axially distributed side-by-side with respect to axis A. Similarly, the inward side 74 of the E/A strap 38 may carry or define a plurality of teeth 80 of the indexing feature 70 (see FIG. 2) configured to adjustably mate with the plurality of teeth 78. An opposite outward side 82 of the E/A strap 38 may be opposed to the base portion 48 of the clamp jaw 42. In one embodiment, the outward side 82 may be configured to slide axially against the base portion 48 during telescopic adjustment and due to the bias of the spring 68.

Referring to FIGS. 3 and 5, the clamp bolt 34 may generally extend through a hole or opening 84 communicating through the wall of the lower jacket 40. An enlarged head 86 of the bolt 34 may be a distal head, and may be disposed radially between the base portion 48 of the clamp jaw 42 and the lower jacket 40. In operation of the steering column 20, and to place the assembly from the unlocked state and into the locked state, the lever 32 is actuated by an operator which causes the bolt to rotate about and move linearly along the centerline C, which may be disposed substantially normal to axis A. The linear motion of the bolt is in the outward direction 53.

As the bolt moves in the outward direction, the enlarged head 86 of the bolt bears against a radially inward side of the lower jacket 40. As the lower jacket 40 moves in the direction 53 along with the bolt 34, the lower jacket 40 contacts and laterally bears upon the upper jacket 44 at a location generally, diametrically, opposite to the locking shoe 46 location. The upper jacket 44 is thus moved with the lower jacket 40 along direction 53. With this movement, the upper jacket 44 bears against the locking shoe 46 and moves the locking shoe along direction 53.

Movement of the locking shoe along direction 53 is conducted against the biasing force of the spring 68. Thus with continued, lateral, motion, the spring 68 may resiliently compress between the clamp jaw 42 (which cannot move along direction 53 because of feet 50, 52 contact with the stationary support structure 30) and the moving locking shoe 46. Compression of the spring 68; and, movement of the bolt 34, the lower jacket 40, the upper jacket 44, and the locking shoe 46 generally ceases when the teeth 78, 80 of the respective locking shoe 46 and E/A strap 38 are mated. When the teeth of the indexing feature 70 mate, the steering column 20 is in the locked state. It is further noted that when the steering column 20 is in the locked state, the E/A strap 38 is generally functional for its intended purpose.

In further operation of the steering column 20, and to at least adjust the steering column telescopically, the assembly must first be placed from the locked state and into the unlocked state. To do this, the locking process previously presented is generally reversed. When unlocking the steering column 20, the force of the spring 68 biases the steering column toward the unlocked state.

When in the unlocked state, the teeth 78, 80 carried by the respective locking shoe 46 and E/A strap 38 are unmated and generally spaced radially apart. This separation permits telescopic motion between the lower and upper jackets 40, 44. During telescopic motion, the E/A strap 38, being engaged to the upper jacket 44, moves axially with respect to the lower jacket 40, the clamp jaw 42, the locking shoe 46 and the spring 68. Therefore, the E/A strap 38 may carry more teeth 80 than the locking shoe 46 to provide a range of telescopic adjustment capability.

Advantages and benefits of the present disclosure may include a steering column having a lower jacket that is less costly to manufacture, is lower in weight from more traditional designs and/or requires less machining. Another advantage may include a lower jacket that is stiffer than more traditional designs due to a decrease in access openings, less parts, a jacket that may have a wall thickness that is thinner than more traditional designs, and/or a jacket that may be made of a continuous fiber composite.

While the invention has been described in detail in connection with only a limited number of embodiments, it should be readily understood that the invention is not limited to such disclosed embodiments. Rather, the invention can be modified to incorporate any number of variations, alterations, substitutions or equivalent arrangements not heretofore described, but which are commensurate with the spirit and scope of the invention. Additionally, while various embodiments of the invention have been described, it is to be understood that aspects of the invention may include only some of the described embodiments. Accordingly, the invention is not to be seen as limited by the foregoing description.

Having thus described the invention, it is claimed:

1. An extendable steering column comprising:
a first jacket extending along an axis;
a second jacket disposed radially inward from the first jacket, the first and second jackets being in telescopic relationship to one-another;
a locking shoe in radial contact with the second jacket;
an energy absorption strap fixed to the second jacket and disposed radially between the first and second jackets;
an indexing feature carried between and defined by the energy absorption strap and the locking shoe for telescopically adjusting the steering column, the indexing feature including a locked state and an unlocked state; and
a spring disposed radially between the shoe and the energy absorption strap, the spring configured to bias the locking shoe radially away from the energy absorption strap and toward the unlocked state.

2. The extendable steering column set forth in claim 1 further comprising:
a fixed support structure; and
an actuator supported by the support structure and configured to move the indexing feature between the locked and unlocked states.

3. The extendable steering column set forth in claim 2, wherein the actuator is a clamping mechanism constructed and arranged to convert rotary motion into linear motion.

4. The extendable steering column set forth in claim 1 further comprising:
a clamp jaw radially disposed at least in-part between the first jacket and the energy absorption strap, the clamp jaw being coupled to the first jacket to restrict axial movement between the clamp jaw and the first jacket.

5. The extendable steering column set forth in claim 4 further comprising:
a stationary support structure, wherein the clamp jaw includes a foot projecting radially outward and through the first jacket.

6. The extendable steering column set forth in claim 5, wherein the foot is in releasable contact with the stationary structure.

7. The extendable steering column set forth in claim 6, wherein the locking shoe includes an arm projecting radially outward and in contact with the clamp jaw for restricting axial movement of the locking shoe with respect to the clamp jaw.

8. The extendable steering column set forth in claim 1, wherein the indexing feature includes a plurality of first teeth carried by the energy absorption strap and a plurality of second teeth carried by the locking shoe and radially opposed to the plurality of first teeth.

9. The extendable steering column set forth in claim 7, wherein the indexing feature includes a plurality of first teeth carried by the energy absorption strap and a plurality of second teeth carried by the locking shoe and radially opposed to the plurality of first teeth.

10. An extendable steering column comprising:
an inner jacket assembly;
an outer jacket assembly in telescopic relation to the inner jacket assembly;
an energy absorption strap fixed to the inner jacket assembly; and
an indexing feature carried between the inner jacket assembly and the energy absorption strap, the indexing feature is configured to move between a locked state preventing telescopic adjustment between the inner and outer jacket assemblies and an unlocked state enabling telescopic adjustment.

11. The extendable steering column set forth in claim 10, further comprising:
a spring carried between the inner jacket assembly and the energy absorption strap for biasing the indexing feature toward the unlocked state.

12. The extendable steering column set forth in claim 11, wherein the inner jacket assembly includes an inner jacket and a locking shoe radially disposed between the inner jacket and the energy absorption strap.

13. The extendable steering column set forth in claim 12, wherein the indexing feature is carried between the locking shoe and the energy absorption strap.

14. The extendable steering column set forth in claim 13, wherein the locking shoe is configured to slide against the inner jacket during telescopic adjustment.

15. The extendable steering column set forth in claim 14, wherein the spring exerts a radial force that biases the locking shoe radially against the inner jacket and biases the energy absorption strap radially against the outer jacket assembly.

16. The extendable steering column set forth in claim 15, wherein the outer jacket assembly includes an outer jacket and a clamp jaw radially disposed between the outer jacket and the energy absorption strap.

17. The extendable steering column set forth in claim 16, wherein contact between the clamp jaw and the locking shoe prevents axial movement of the locking shoe and the spring with respect to the clamp jaw and the outer jacket as the inner jacket telescopically moves axially when the indexing feature is in the unlocked state.

18. The extendable steering column set forth in claim 17, wherein contact between the clamp jaw and the outer jacket prevents axial movement of the clamp jaw with respect to the outer jacket as the inner jacket telescopically moves axially when the indexing feature is in the unlocked state.

19. The extendable steering column set forth in claim 11, wherein the spring is a spring clip engaged to the locking shoe.

20. The extendable steering column set forth in claim 18, further comprising:
a fixed support structure;
an actuator supported by the fixed support structure and in contact with the outer jacket, the actuator configured to move the outer jacket, the inner jacket, the locking shoe and at least a portion of the spring along a centerline disposed substantially normal to the axis when moving between the locked and unlocked states.
